(19) United States
(12) Patent Application Publication
(10) Pub. No.: US 2026/0025293 A1
(43) Pub. Date: Jan. 22, 2026

(54) SEMICONDUCTOR DEVICE AND COMMUNICATION SYSTEM

(71) Applicant: ROHM CO., LTD., Kyoto (JP)

(72) Inventor: Kei NAGAO, Kyoto (JP)

(21) Appl. No.: 19/269,409

(22) Filed: Jul. 15, 2025

(30) Foreign Application Priority Data
Jul. 22, 2024 (JP) 2024-116927

(51) Int. Cl. H04L 12/40; H04L 25/40

(52) U.S. Cl. CPC H04L 12/40058; H04L 25/40

(57) ABSTRACT

In a semiconductor device, when bridge selection data included in reception data indicates an on-state of a through-output in which bit data is output as is, data for a first device included in the reception data is through-output from a second output terminal; transmission data received by a second receiving section via a second input terminal during the through-output of the reception data is stored in a buffer; and the transmission data read from the buffer after the through-output of the reception data is output via a first output terminal by a second transmitting section.

### TECHNICAL FIELD

The present disclosure relates to a semiconductor device.

### BACKGROUND

Semiconductor devices comprising serial communication functions are used in various applications.

Furthermore, an example of circuit technology related to serial communication is disclosed in Patent Document 1.

### PRIOR ART DOCUMENT

### Patent Document

[Patent document 1] Japan Patent Publication No. 2017-224946.

### BRIEF DESCRIPTION OF THE DRAWINGS

FIG. 1 is a diagram showing a configuration of a communication system according to a first comparative example.

FIG. 2 is a diagram showing a configuration of a communication system according to a second comparative example.

FIG. 3 is a diagram showing a configuration of a communication system according to an exemplary embodiment of the present disclosure.

FIG. 4 is a block diagram of a semiconductor device according to an exemplary embodiment of the present disclosure.

FIG. 5 is a block diagram of a semiconductor device according to an exemplary embodiment of the present disclosure.

FIG. 6 is a diagram showing a data configuration of reception data RX when a Write or Read is performed with a semiconductor device 1 as a target device.

FIG. 7 is a diagram showing a configuration example of a communication system according to an embodiment of the present disclosure.

FIG. 8 is a diagram showing a data configuration of reception data RX when a Write or Read is performed with a device 10 as a target device.

FIG. 9 is a timing chart showing communication control when a Write is performed on a device 10.

FIG. 10 is a timing chart showing communication control when a Read is performed on a device 10.

FIG. 11 is a diagram showing a configuration example of a communication system according to an embodiment of the present disclosure.

FIG. 12A is a table showing communication method setting information BRIFSEL.

FIG. 12B is a table showing clock edge setting information CPOL.

FIG. 12C is a table showing chip select signal setting information CSF.

FIG. 12D is a table showing clock edge setting information CPOLR.

FIG. 13 is a timing chart showing an example of operation when a Write is performed on an SPI device.

FIG. 14 is a diagram showing a data configuration of reception data RX when a Write or Read is performed with an SPI device as the target device.

FIG. 15 is a timing chart showing an example of operation when a Read is performed on an SPI device.

FIG. 16 is a diagram showing an overview of an example of operation of SPI communication using Full Duplex.

FIG. 17 is a diagram showing a configuration of a CAN transceiver.

FIG. 18 is a timing chart showing more specifically a processing after a second data number frame ND2 in FIG. 16.

FIG. 19 is a diagram showing a configuration example of a motor driver.

FIG. 20 is an external view showing an example of a vehicle.

### DETAILED DESCRIPTION OF THE EMBODIMENTS

Hereinafter, exemplary embodiments of the present disclosure are illustrated with reference to figures.

### 1. Communication System

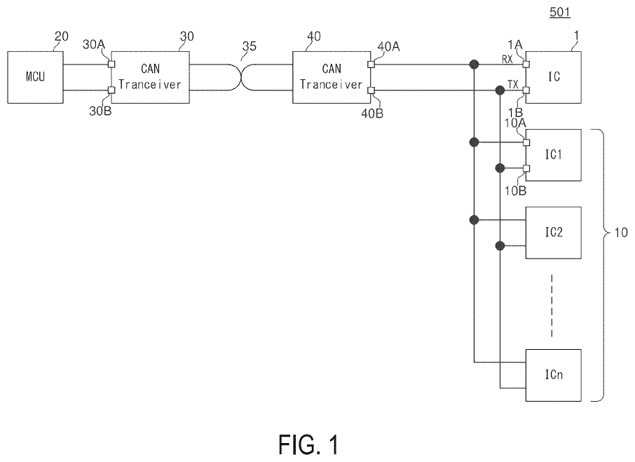

FIG. 1 is a diagram showing a configuration of a communication system 501 according to a first comparative example for comparison with embodiments of the present disclosure. The communication system 501 comprises an MCU (Micro Controller Unit) 20, a CAN (Controller Area Network) transceiver 30, a CAN transceiver 40, a semiconductor device 1, and n (n is an integer of 1 or more) devices 10. The communication system 501 is for in-vehicle use, as an example, and the same applies to other communication systems illustrated below.

Between the MCU 20 and the CAN transceiver 30, communication is conducted using UART (Universal Asynchronous Receiver/Transmitter) as a communication method. UART is a protocol for exchanging serial data between two devices. In UART, bidirectional communication is conducted over two lines between a transmitting side and a receiving side.

Communication between the CAN transceivers 30 and 40 is conducted via a CAN bus 35. CAN is a serial communication protocol standardized in international standards such as ISO 11898. In CAN, a differential voltage method that transmits data based on a level of a voltage difference generated between two communication lines is used. Communication between the CAN transceiver 40, the semiconductor device 1, and the n devices 10 is conducted via UART.

The CAN transceiver 30 comprises a TXD (Transmission Data Input) terminal 30A and an RXD (Reception Data Output) terminal 30B. The CAN transceiver 30 outputs data input to the TXD terminal 30A to the CAN bus 35 and outputs data input from the CAN bus 35 from the RXD terminal 30B.

The CAN transceiver 40 comprises an RXD terminal 40A and a TXD terminal 40B. The CAN transceiver 40 outputs data input to the TXD terminal 40B to the CAN bus 35 and outputs data input from the CAN bus 35 from the RXD terminal 40A.

The semiconductor device 1 is an IC (Integrated Circuit) in which circuits for specific functions are integrated, and is configured, for example, as an LED (Light Emitting Diode) driver IC. The n devices 10 are ICs in which circuits for specific functions are integrated, and are configured as, for example, matrix switch ICs.

The semiconductor device 1 comprises an RX (Reception Data Input) terminal 1A and a TX (Transmission Data Output) terminal 1B. The device 10 comprises an RX terminal 10A and a TX terminal 10B. The RX terminal 1A and the n RX terminals 10A are commonly connected to an RXD terminal 40A. The TX terminal 1B and the n TX terminals 10B are commonly connected to a TXD terminal 40B.

In the first comparative example shown in FIG. 1, since the semiconductor device 1 and the n devices 10 correspond to the same protocol, the semiconductor device 1 and the n devices 10 can be commonly connected to the same CAN transceiver 40. Reception data RX output from the RXD terminal 40A is input to the RX terminal 1A and the n RX terminals 10A. The reception data RX specifies a device address of either the semiconductor device 1 or one of the n devices 10. Additionally, transmission data TX output from the TX terminal 1B and the n TX terminals 10B is input to the TXD terminal 40B.

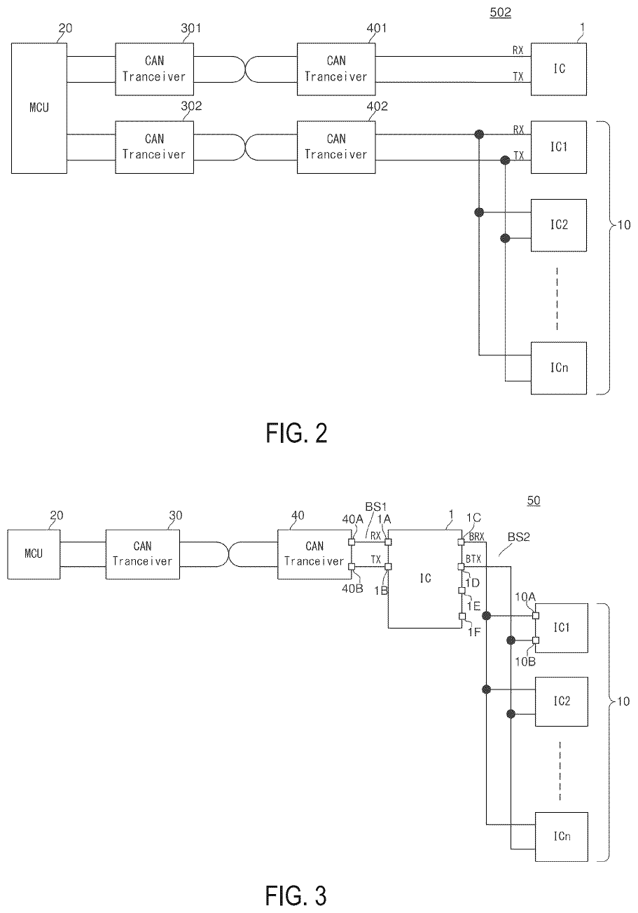

However, if the protocols that the semiconductor device 1 and the n devices 10 correspond to are different, it becomes difficult to accommodate the configuration of the first comparative example as shown in FIG. 1. Thus, in such cases, a configuration of a second comparative example shown in FIG. 2 can be adopted.

A communication system 502 according to the second comparative example shown in FIG. 2 differs from the first comparative example in that CAN transceivers 301 and 302 are used instead of the CAN transceiver 30, and CAN transceivers 401 and 402 are used instead of the CAN transceiver 40. The semiconductor device 1 is connected to the MCU 20 via the CAN transceiver 301 and the CAN transceiver 401, and the n devices 10 are connected to the MCU 20 via the CAN transceiver 302 and the CAN transceiver 402. The CAN transceivers 401, 402 each conducts CAN communication with CAN transceivers 301, 302, respectively.

As such, by grouping devices having different protocols (a group of semiconductor device 1 and a group of n devices 10), communication control can be performed using devices having different protocols. However, as a number of CAN transceivers, such as the CAN transceivers 301, 302, 401, 402, increases, an amount of wiring increases, leading to an issue of rising costs.

Therefore, to solve such issues, embodiments of the present disclosure are implemented as illustrated below. FIG. 3 is a diagram showing a configuration of a communication system 50 according to an exemplary embodiment of the present disclosure.

In the configuration shown in FIG. 3, communication is conducted by UART between the CAN transceiver 40, the semiconductor device 1, and the n devices 10. The semiconductor device 1 comprises an RXD (Reception Data Output) terminal 1C and a TXD (Transmission data Input) terminal 1D in addition to the RX terminal 1A and the TX terminal 1B. The RX terminal 1A is connected to the RXD terminal 40A of the CAN transceiver 40. The TX terminal 1B is connected to the TXD terminal 40B of the CAN transceiver 40. That is, the RX terminal 1A and the TX terminal 1B are connected to the RXD terminal 40A and the TXD terminal 40B via a bus BS1. Communication of the reception data RX and the transmission data TX is possible via the bus BS1. The reception data RX and the transmission data TX are serial data.

The RXD terminal 1C is connected to the RX terminal 10A of the n devices 10. The TXD terminal 1D is connected to the TX terminal 10B of the n devices 10. That is, the RXD terminal 1C and the TXD terminal 1D are connected to the RX terminal 10A and the TX terminal 10B via a bus (local bus) BS2. Communication of reception data BRX and transmission data BTX is possible via the bus BS2. The reception data BRX and the transmission data BTX are serial data.

Furthermore, the semiconductor device 1 also comprises a CS terminal (Chip Select Terminal) 1E and an SCK terminal (Clock Terminal) 1F. As described below, the CS terminal 1E is a terminal for outputting a chip selection signal, and the SCK terminal IF is a terminal for outputting a clock signal. The terminals 1E and 1F are employed when using a device corresponding to an SPI (Serial Peripheral Interface) communication method, as described below, and as shown in FIG. 3, when a device 10 corresponding to UART is used, the terminals 1E and 1F are not employed.

In a configuration according to an embodiment of the present disclosure shown in FIG. 3, the semiconductor device 1 and the n devices 10 correspond to different protocols. When the CAN transceiver 40 performs a Write or Read on the semiconductor device 1, the reception data RX output from the RXD terminal 40A to the RX terminal 1A consists only of data corresponding to the protocol of the semiconductor device 1. Furthermore, Write is a process of writing data to a target device, and Read is a process of reading data from the target device. In a case of Read, after receiving the reception data RX, the semiconductor device 1 outputs the transmission data TX from the TX terminal 1B to the TXD terminal 40B.

On the other hand, when the CAN transceiver 40 performs a Write or Read on the device 10, the reception data RX output from the RXD terminal 40A to the RX terminal 1A includes data corresponding to the protocol of the device 10. At this time, the semiconductor device 1 turns on a bridge function and through-outputs data corresponding to the protocol of the device 10 included in the reception data RX as reception data BRX from the RXD terminal 1C. Through-output means outputting bit data as is. A device address of the device 10 is specified for the reception data BRX.

In the case of Read, the device 10, which is the target device (specified by the device address), outputs the transmission data BTX from the TX terminal 10B to the TXD terminal 1D. Since the bridge function is on, the semiconductor device 1 through-outputs the transmission data BTX as transmission data TX from the TX terminal 1B.

As such, according to the embodiment of the present disclosure, even if the protocols of the semiconductor device 1 and the device 10 are different, the CAN transceiver 40 can perform Write and Read on the semiconductor device 1 and the device 10, respectively. Compared to the second comparative example (FIG. 2), the number of CAN transceivers can be reduced, and the amount of wiring can be decreased, thereby reducing costs.

### 2. Configuration of Semiconductor Device

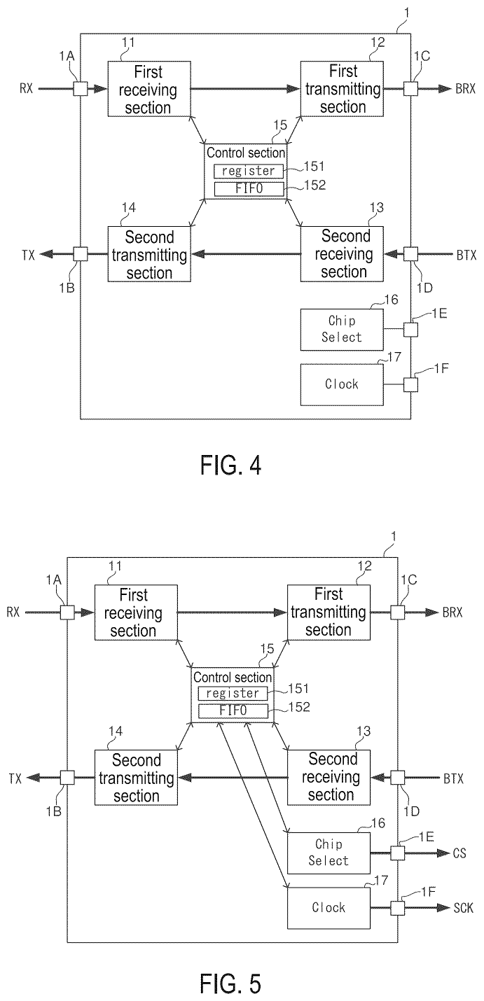

FIG. 4 is a block diagram of a semiconductor device 1 according to an embodiment of the present disclosure. The semiconductor device 1 comprises, as functional blocks, a first receiving section 11, a first transmitting section 12, a second receiving section 13, a second transmitting section 14, and a control section 15. Furthermore, FIG. 4 shows only functional blocks related to communication functions, and may comprise other functional blocks. For example, if the semiconductor device 1 is an LED driver, it may comprise block functions related to LED driving.

The first receiving section 11 receives the reception data RX via the RX terminal 1A. The first transmitting section 12 outputs the reception data BRX via the RXD terminal 1C. The second receiving section 13 receives the transmission data BTX via the TXD terminal 1D. The second transmitting section 14 outputs the transmission data TX via the TX terminal 1B.

The control section 15 controls the first receiving section 11, the first transmitting section 12, the second receiving section 13, and the second transmitting section 14. The control section 15 comprises a register 151 and a buffer 152. The buffer 152 is configured as a FIFO (First In First Out) memory.

Furthermore, as shown in FIG. 4, the semiconductor device 1 also comprises a chip select signal output section 16 and a clock signal output section 17. FIG. 4 is a diagram showing a state of the semiconductor device 1 when the device 10 corresponding to UART is used, as shown in FIG. 3. The chip select signal output section 16 and the clock signal output section 17 are not employed in the state shown in FIG. 4. On the other hand, FIG. 5 is a diagram showing a state of the semiconductor device 1 when a device corresponding to SPI is used as described below. As shown in FIG. 5, the chip select signal output section 16 outputs chip select signal CS via the CS terminal 1E. The clock signal output section 17 outputs clock signal SCK via the SCK terminal 1F. The chip select CS signal and the clock signal SCK are necessary signals for communication via SPI and are used together with the reception data BRX and the transmission data BTX.

### 3. Configuration of Reception Data

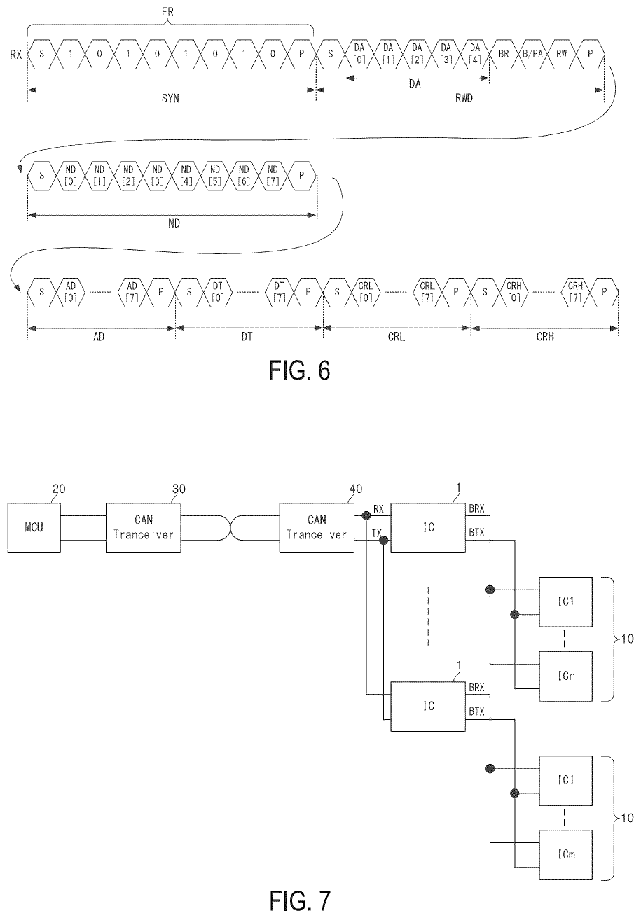

FIG. 6 is a diagram showing a data configuration of the reception data RX when a Write or Read is performed with the semiconductor device 1 as the target device. The reception data RX shown in FIG. 6 consists only of data corresponding to the protocol of the semiconductor device 1.

In UART, communication is conducted using data units called frames. As shown in FIG. 6, a frame FR comprises bit data from a start bit S to a stop bit P. The start bit S is at a low level, and the stop bit P is at a high level. Between the start bit S and the stop bit P, a predetermined number of bits of bit data are arranged. In an example of FIG. 6, 8 bits of bit data are arranged. That is, the frame FR comprises 10 bits of bit data.

As shown in FIG. 6, the reception data RX comprises, in order from the beginning, a synchronization frame SYN, a Read/Write, etc. frame RWD, a data number frame ND, a register address frame AD, a data frame DT, and CRC (Cyclic Redundancy Check) frames CRL, CRH.

The synchronization frame SYN is bit data for setting a baud rate in the semiconductor device 1.

The Read/Write, etc. frame RWD includes a device address DA, a bridge bit BR, a broadcast/parity bit B/PA, and a Read/Write bit RW. The device address DA is bit data indicating an address of the target device (semiconductor device 1) (5-bit data in the example of FIG. 6). The bridge bit BR is bit data indicating whether a bridge function of the semiconductor device 1 is on or off. The broadcast/parity bit B/PA is bit data indicating whether a broadcast of the semiconductor device 1 is on or off or a parity of the data address DA. The Read/Write bit RW is bit data indicating Read or Write.

Herein, the bridge bit BR=0 indicates that the bridge function is off, i.e., a normal mode (in the reception data RX shown in FIG. 6, the bridge function is off). In this case, the broadcast/parity bit B/PA indicates whether the broadcast is on or off. When the broadcast/parity bit B/PA=0, it indicates that broadcast is off; when the broadcast/parity bit B/PA=1, it indicates that broadcast is on.

Furthermore, when the broadcast of the semiconductor device 1 is performed, as shown in FIG. 7, multiple semiconductor devices 1 are connected to the CAN transceiver 40. The device 10 is connected to each of the semiconductor devices 1. When the broadcast is on, all of the multiple semiconductor devices 1 become target devices.

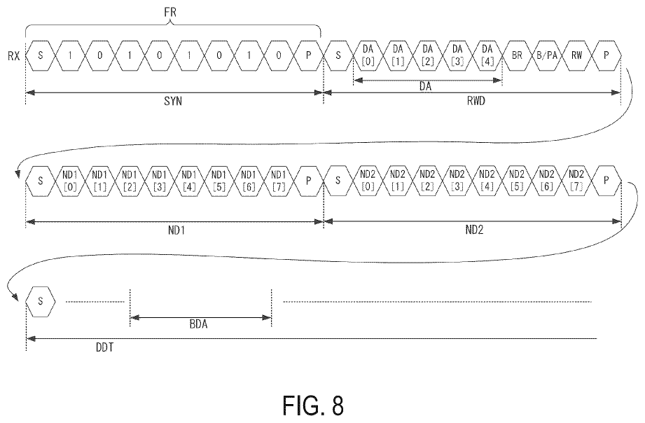

The bridge bit BR=1 indicates that the bridge function is on (in the reception data RX shown in FIG. 8 described below, the bridge function is on). In this case, the broadcast/parity bit B/PA becomes the parity of the device address DA. As a result, error detection of the device address DA can be performed. Furthermore, in a configuration shown in FIG. 7, if the protocols differ for each group of devices 10 connected to each of the multiple semiconductor devices 1, when the broadcast of the semiconductor device 1 is turned on, the same reception data RX would be transmitted as the reception data BRX to the devices 10 having different protocols, resulting in incompatibility with the protocols of some devices 10. Therefore, when the bridge function is on, the broadcast is made not to be performed.

The data number frame ND is bit data that indicates a number of frames in the data frame DT, which is a frame of Write data of the target device.

The register address frame AD is bit data that indicates an address in the register 151. The data frame DT is bit data that includes Write data. Furthermore, in FIG. 6, as an example, the number of frames in the data frame DT (the number of frames indicated by the data number frame ND)=1, but it may be 2 or more. CRC frames CRL and CRH are bit data that indicate error detection codes added to the data frame DT. Furthermore, the 16-bit CRC data is divided into two frames CRL (lower 8 bits) and CRH (upper 8 bits).

In the first receiving section 11, the baud rate is set using the synchronization frame SYN, and thereafter, each bit of each frame is sampled according to the set baud rate, and a bit value is obtained. During a Write process, checking Write data included in the data frame DT is performed based on the CRC data included in the CRC frames CRL and CRH, and if no anomalies are found during the check, the Write data is written into the register 151. Therefore, the Write data is temporarily stored in the buffer 152.

FIG. 8 is a diagram showing a data configuration of the reception data RX when a Write or Read is performed with the device 10 as the target device. The synchronization frame SYN and the Read/Write, etc. frame RWD in the reception data RX shown in FIG. 8 are as described above.

In the reception data RX shown in FIG. 8, the second data number frame ND2 is followed by device data DDT. The device data DDT is data corresponding to the protocol of the device 10 and is the target for through-output as reception data BRX. The device data DDT includes a device address BDA. The device address BDA indicates the address of the target device, the device 10. A position where the device address BDA is arranged in the device data DDT is a position depending on the protocol of device 10.

### 4. Through-Output Control

Herein, the through-output control by the semiconductor device 1, i.e., the control when the bridge function is on, is described.

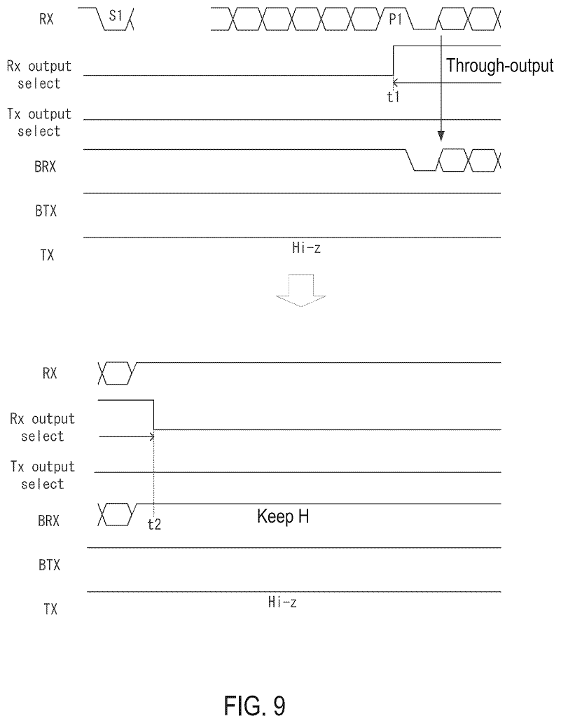

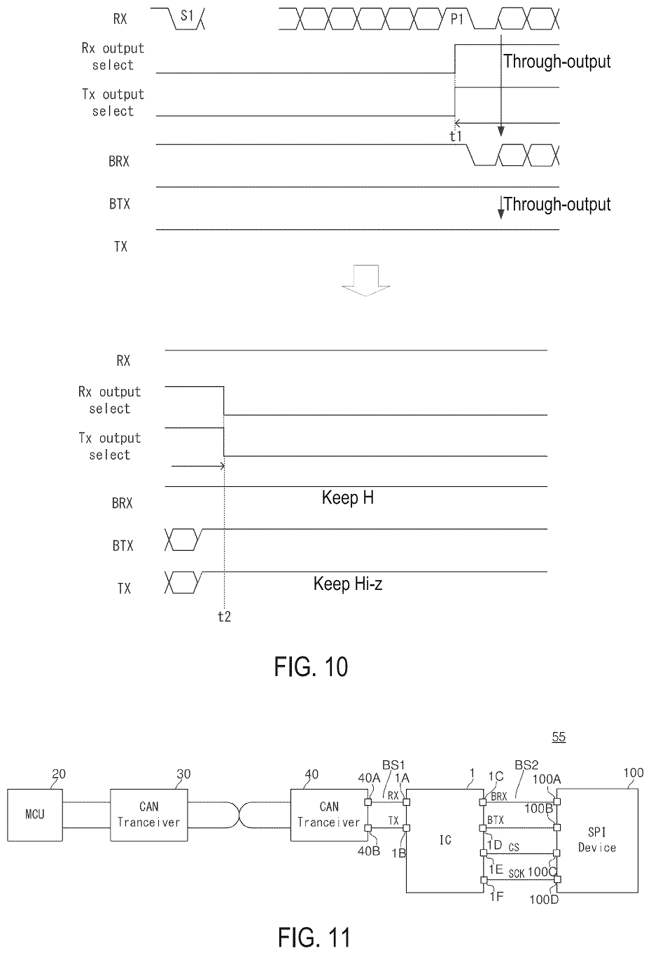

FIG. 9 is a timing chart showing communication control when a Write is performed on the device 10. In order from top of FIG. 9, reception data RX, a reception data output selection signal (RX output select), a transmission data output selection signal (TX output select), reception data BRX, transmission data BTX, and transmission data TX are shown (similarly in FIG. 10). The reception data RX has the configuration shown in FIG. 8.

The reception data RX is received by the first receiving section 11 (FIG. 4). Upon receiving a start bit S1 (low level) at the beginning of the reception data RX, the control section 15 recognizes a start of reception of the reception data RX. Subsequently, the control section 15 recognizes that the bridge function is on by the bridge bit BR included in the reception data RX, and also recognizes that it is Write by the Read/Write bit RW.

Subsequently, when the second data number frame ND2 is received, the control section 15 sets the reception data output selection signal in the register 151 from a low level to a high level at a stop bit P1 of the second data number frame ND2 (timing t1). As a result, the through-output of the reception data RX is started, and the first receiving section 11 and the first transmitting section 12 output the reception data RX as the reception data BRX as is. That is, the through-output of the device data DDT (FIG. 8) is performed.

When the reception data output selection signal becomes high level, the control section 15 starts counting a number of frames of the reception data RX (i.e., a number of frames of the device data DDT). When the counted number of frames reaches a number of frames indicated by the received second data number frame ND2, the control section 15 switches the reception data output selection signal to low level and stops the through-output (timing t2). Thereafter, the reception data BRX is kept at a high level. Furthermore, in this case, the number of frames indicated by the second data number frame ND2 matches a number of frames indicated by the first data number frame ND1.

FIG. 10 is a timing chart showing communication control when a Read is performed on the device 10. In this case, the reception data RX has the configuration shown in FIG. 8.

After the start bit S1 (low level) at the beginning of the reception data RX is received, the control section 15 recognizes that the bridge function is on by the bridge bit BR included in the reception data RX, and also recognizes that it is Read by the Read/Write bit RW.

Subsequently, when the second data number frame ND2 is received, the control section 15 sets both the reception data output selection signal and the transmission data output selection signal in the register 151 from a low level to a high level at the stop bit PI of the second data number frame ND2 (timing t1). As a result, the through-output of the reception data RX and the transmission data BTX is started. The first receiving section 11 and the first transmitting section 12 output the reception data RX as the reception data BRX as is, that is, the through-output of the device data DDT (FIG. 8) is performed. After the output of the reception data BRX is completed, the second receiving section 13 and the second transmitting section 14 through-output the transmission data BTX transmitted from the device 10 as the transmission data TX.

When the reception data output selection signal and the transmission data output selection signal become high level, the control section 15 starts counting the number of frames of the reception data RX. When a sum of a number of frames counted for the reception data RX and a number of frames counted for the transmission data BTX that is subsequently received reaches the number of frames indicated by the first data number frame ND1, the control section 15 switches both the reception data output selection signal and the transmission data output selection signal to low level, stopping the through-output (timing t2). Thereafter, the transmission data TX is kept at Hi-Z (high impedance).

As such, in this embodiment, a condition for ending the through-output can be determined based on the number of frames received by the semiconductor device 1. Particularly, according to this embodiment, even if the transmission of the reception data RX from the MCU 20 is interrupted due to interrupt processing in the MCU 20, counting the number of frames does not progress during the interruption, and therefore it is possible to avoid the through-output being interrupted erroneously. That is, since the interruption of through-output can be avoided regardless of interrupt time, it is less subject to restrictions due to specifications of the MCU 20.

### 5. Conversion between UART and SPI

The semiconductor device 1 of this embodiment can also be connected to an external device that corresponds to communication using SPI. FIG. 11 is a diagram showing a communication system 55 comprising the semiconductor device 1 and an SPI device 100 corresponding to SPI. Furthermore, the SPI device 100 is configured as a semiconductor device having various functions, such as a motor driver as described below.

The SPI device 100 comprises an RX terminal 100A, a TX terminal 100B, a CS terminal 100C, and an SCK terminal 100D.

The RXD terminal 1C of the semiconductor device 1 is connected to the RX terminal 100A. The TXD terminal ID of the semiconductor device 1 is connected to the TX terminal 100B. The reception data BRX output from the RXD terminal 1C is input to the RX terminal 100A. The transmission data BTX output from the TX terminal 100B is input to the TXD terminal 1D.

The CS terminal 1E of the semiconductor device 1 is connected to the CS terminal 100C. The SCK terminal 1F of the semiconductor device 1 is connected to the SCK terminal 100D. The chip select signal CS output from the CS terminal 1E is input to the CS terminal 100C. The clock signal SCK output from the SCK terminal 1F is input to the SCK terminal 100D. That is, communication between the semiconductor device 1 and the SPI device 100 is conducted via the bus BS2 using each of the signals BRX, BTX, CS, SCK.

The semiconductor device 1 operates as a master, and the SPI device 100 operates as a slave. When reception data BRX is transmitted from the semiconductor device 1 to the SPI device 100, the semiconductor device 1 transmits the clock signal SCK from the semiconductor device 1 to the SPI device 100. The semiconductor device 1 transmits the reception data BRX in synchronization with the clock signal SCK. The SPI device 100 receives the reception data BRX in synchronization with the clock signal SCK.

Even when transmitting data from the SPI device 100 to the semiconductor device 1, the semiconductor device 1 transmits the clock signal SCK to the SPI device 100. The SPI device 100 transmits the transmission data BTX in synchronization with the clock signal SCK. The semiconductor device 1 receives the transmission data BTX in synchronization with the clock signal SCK.

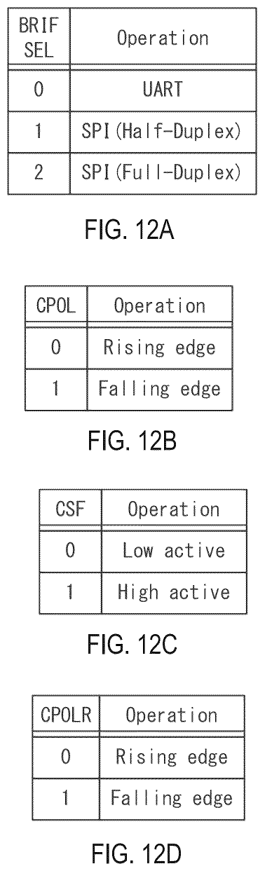

Next, operations of the communication system 55 having such a configuration are illustrated in more detail. Herein, the register 151 of the semiconductor device I can be set with communication method setting information BRIFSEL, as shown in FIG. 12A. The communication method setting information BRIFSEL indicates a communication method corresponding to a device connected to the semiconductor device 1. In an example of FIG. 12A, the communication method setting information BRIFSEL=0 indicates UART, BRIFSEL=1 indicates SPI by Half Duplex (Half Duplex Communication), and BRIFSEL=2 indicates SPI by Full Duplex (Full Duplex Communication). Half Duplex is a method of conducting bidirectional communication where data is alternately transmitted between two devices. Full Duplex is a method of conducting bidirectional communication where data is simultaneously transmitted between two devices. For example, when the device 10 corresponding to UART (FIG. 3) is connected, BRIFSEL=0; when the SPI device 100 (FIG. 11) is connected, BRIFSEL=1 or 2. The operation switches according to the setting of BRIFSEL.

Furthermore, various settings using the communication method setting information BRIFSEL, etc. are not limited to settings in the registers; they can also be performed, for example, by resistors, etc. which are connected to an outside of the semiconductor device.

### SPI (Half Duplex)

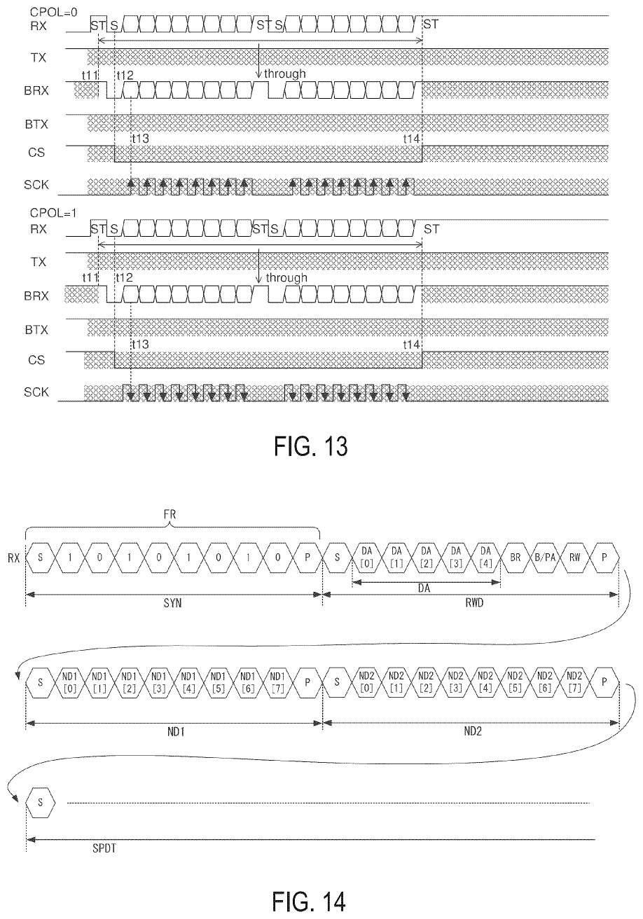

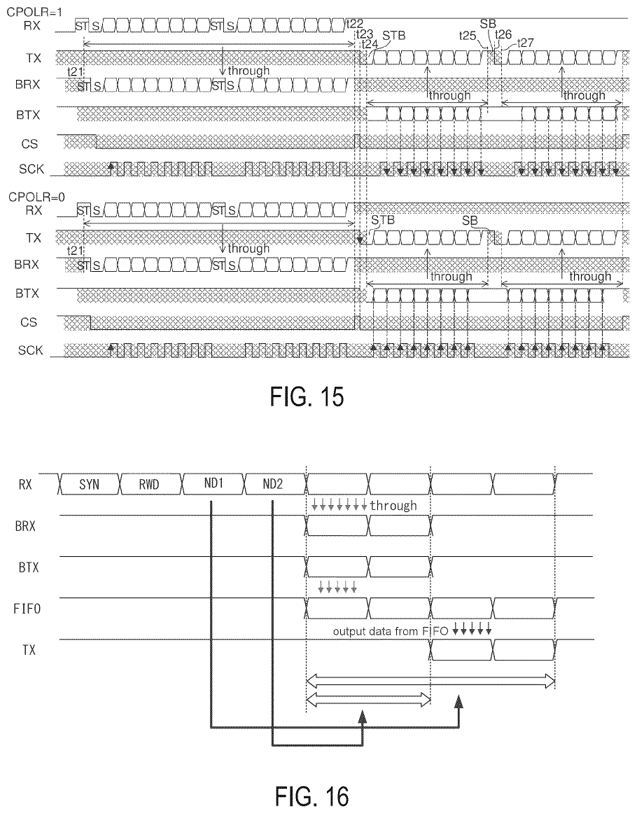

Herein, operations when SPI by Half Duplex is set as the communication method in the semiconductor device 1 (BRIFSEL=1) are illustrated. First, the operation when a Write is performed on the SPI device 100 is illustrated with reference to a timing chart shown in FIG. 13. In FIG. 13 (and FIG. 15 described below), in order from top, each waveform example for reception data RX, transmission data TX, reception data BRX, transmission data BTX, a chip select signal CS, and a clock signal SCK is shown.

Furthermore, in FIG. 13, waveforms divided into cases by a value of clock edge setting information CPOL are shown. The clock edge setting information CPOL can be set in the register 151 and is information indicating an edge (rising or falling) of the clock signal SCK at a center of each bit of the reception data BRX. In an example shown in FIG. 12B, CPOL=0 indicates a rising edge, and CPOL=1 indicates a falling edge.

Furthermore, in FIG. 13 (and FIG. 15), hatching indicates signal control other than through-output.

As shown in FIG. 14, the reception data RX includes a synchronization frame SYN, a Read/Write, etc. frame RWD, a first data number frame ND1, and a second data number frame ND2, similar to FIG. 8. In the reception data RX shown in FIG. 14, after the second data number frame ND2, data SPDT for the SPI device 100 is included.

After the start bit (low level) at the beginning of the reception data RX is received, the control section 15 recognizes that the bridge function is on by the bridge bit BR included in the reception data RX, and recognizes that it is Write by the Read/Write bit RW.

Subsequently, when the second data number frame ND2 is received, the control section 15 starts the through-output of the reception data RX at a stop bit ST of the second data number frame ND2 (timing t11). As a result, the data SPDT is through-output as reception data BRX to the SPI device 100. At this time, the chip select signal CS is switched to active by the chip select signal output section 16 at a start bit at the beginning of the data SPDT (timing t12).

Herein, the register 151 can be set with chip select signal setting information CSF. The chip select signal setting information CSF is information that sets a level when the chip select signal CS is active. For example, as shown in FIG. 12C, when CSF=0, the chip select signal CS becomes active at a low level; when CSF=1, the chip select signal CS becomes active at a high level. FIG. 13 shows a case in which the chip select signal CS is set to be active at a low level.

Additionally, when the clock edge setting information CPOL=0, the clock signal SCK is output so that a rising edge matches a center of each bit (bits sandwiched between a start bit and a stop bit) of the transmission data BRX that is through-output of the data SPDT; when CPOL=1, the clock signal SCK is output so that a falling edge matches the center of each bit of the transmission data BRX that is through-output of the data SPDT (timing t13).

When the number of frames of the reception data RX to be through-output reaches the number of frames indicated by the second data number frame ND2 (in FIG. 13, the number of frames=2), the through-output is stopped by the control section 15 (timing t14). In this case, the number of frames indicated by the second data number frame ND2 matches the number of frames indicated by the first data number frame ND1.

Next, operations when a Read is performed on the SPI device 100 is illustrated with reference to a timing chart shown in FIG. 15. Furthermore, FIG. 15 shows waveforms divided into cases by a value of the clock edge setting information CPOLR. The clock edge setting information CPOLR can be set in the register 151 and is information indicating an edge (rising or falling) of the clock signal SCK at a beginning of each bit of the transmission data BTX. In an example shown in FIG. 12D, CPOLR=0 indicates a rising edge, and CPOLR=1 indicates a falling edge. Additionally, in FIG. 15, the chip select signal CS is active at a low level.

After the start bit (low level) at the beginning of the reception data RX is received, the control section 15 recognizes that the bridge function is on by the bridge bit BR included in the reception data RX, and recognizes that it is Read by the Read/Write bit RW.

Subsequently, when the second data number frame ND2 is received, the control section 15 starts the through-output of the reception data RX at a stop bit ST of the second data number frame ND2 (timing t21). The operation of the subsequent through-output of the data SPDT is the same as that of the Write described above, and the detailed description is omitted. Then, when the through-output is stopped, the chip select signal CS is switched to a high level, and the active state is released (timing t22).

Then, as the transmission data TX is set to a low level, the chip select signal CS is switched to a low level and becomes active (timing t23). Then, regardless of the setting of CPOLR, the through-output of the transmission data BTX starts (timing t24). As a result, the transmission data BTX is through-output as transmission data TX. In the transmission data TX, a start bit STB is added at the beginning.

When CPOLR=1, the falling edge of the clock signal SCK occurs at the beginning of each bit of the transmission data BTX. When CPOLR=0, the rising edge of the clock signal SCK occurs at the beginning of each bit of the transmission data BTX.

When a predetermined number of bits (8 bits in FIG. 15) of the transmission data BTX are through-output, the transmission data TX is set to a high level by the control section 15, and the through-output is stopped (timing t25). Subsequently, the transmission data TX is set to a low level by the control section 15 (timing t26). As a result, a stop bit SB used in URAT can be added to the transmission data BTX transmitted from the SPI device 100 to generate the transmission data TX.

Subsequently, the through-output of the transmission data BTX resumes (timing t27), and the clock signal SCK is output. When the number of frames of the transmission data TX generated based on the transmission data BTX reaches a number of frames obtained by subtracting a number of frames indicated by the second data number frame ND2 from a number of frames indicated by the first data number frame ND1 (in the example of FIG. 15, the number of frames=4−2=2), the process is completed.

As such, according to the semiconductor device 1 of this embodiment, conversion between UART format and SPI format becomes possible, and the MCU20 can perform Write or Read on the SPI device 100 via the semiconductor device 1.

### <<SPI (Full Duplex)>>

Next, operations when SPI by Full Duplex is set as the communication method in the semiconductor device 1 (BRIFSEL=2) are illustrated.

FIG. 16 is a diagram showing an overview of an example of operation of SPI communication using Full Duplex. Furthermore, in FIG. 16, in order from top, reception data RX, reception data BRX, transmission data BTX, data stored in buffer 152 (FIFO), and transmission data TX are shown.

When the synchronization frame SYN to the second data number frame ND2 in the reception data RX are received by the first receiving section 11, frames (i.e., data SPDT) of the number of frames indicated by the second data number frame ND2 (the number of frames for Write) are through-output as the reception data BRX. In the example of FIG. 16, the second data number frame ND2 indicates that the number of frames=2.

At this time, due to Full Duplex, the transmission data BTX is output from the SPI device 100, and the transmission data BTX is stored in the buffer 152. The transmission data BTX may be, for example, status information of the SPI device 100. Subsequently, the data stored in the buffer 152 is read and made to be frames, and transmitted as the transmission data TX. The number of frames of frames transmitted at this time is a value obtained by subtracting the number of frames indicated by the second data number frame from the number of frames indicated by the first data number frame ND1 (total number of frames). In the example of FIG. 16, the first data number frame ND1 indicates that the number of frames=4. Furthermore, the data stored in the buffer 152 corresponds to the number of frames in the transmission data BRX, so the number of frames indicated by the first data number frame NDI is twice the number of frames indicated by the second data number frame ND2.

As such, even in the case where the SPI device 100 transmits the transmission data BTX while the reception data BRX is being transmitted to the SPI device 100 via Full Duplex, the semiconductor device 1 can transmit the transmission data TX after receiving the reception data RX. If the transmission data BTX is not stored in the buffer and is output as is as the transmission data TX, the transmission data TX is mirrored by the CAN transceiver 40 (FIG. 11) and becomes the reception data RX, causing a conflict with the original reception data RX. Therefore, it is necessary to temporarily store the transmission data BTX in the buffer.

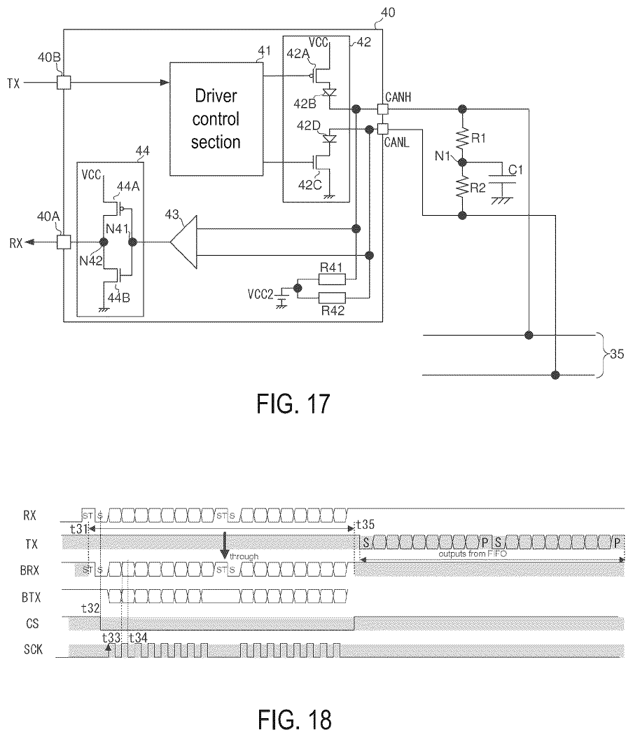

Herein, FIG. 17 is a diagram showing a configuration of the CAN transceiver 40. The CAN transceiver 40 comprises a driver control section 41, a driver 42, a receiver 43, and an output section 44. Additionally, the CAN transceiver 40 comprises a TXD terminal 40B, an RXD terminal 40A, a CANH terminal, and a CANL terminal.

The CANH terminal and the CANL terminal are each connected to respective lines of the CAN bus 35. Between the CANH terminal and the CANL terminal, termination resistors R1 and R2 are connected in series. Resistance values of the termination resistors are defined by ISO 11898, and each of the termination resistors R1 and R2 comprises a 60Ω resistor. One end of capacitor C1 is connected to a connection node NI where the resistors R1 and R2 are connected.

The driver 42 comprises a PMOS transistor (P-channel MOSFET (metal-oxide-semiconductor field-effect transistor)) 42A, a diode 42B, an NMOS transistor (N-channel MOSFET) 42C, and a diode 42D. A source of the PMOS transistor 42A is connected to an application terminal of power supply voltage VCC. A drain of the PMOS transistor 42A is connected to an anode of the diode 42B. A cathode of the diode 42B is connected to the CANH terminal. A source of the NMOS transistor 42C is connected to a ground terminal. A drain of the NMOS transistor 42C is connected to a cathode of the diode 42D. An anode of the diode 42D is connected to the CANL terminal. The diodes 42B and 42D are used to prevent backflow when a surge occurs.

The driver control section 41 controls on/off states of the PMOS transistor 42A and the NMOS transistor 42C based on the transmission data TX input from an outside via the TXD terminal 40B.

More specifically, when the PMOS transistor 42A and the NMOS transistor 42C are in the on-state, a current flowing through the termination resistors R1 and R2 is common, so the voltage drops occurring in each termination resistors R1 and R2 are the same, and high-side signal CANH occurring at the CANH terminal is a voltage higher than a voltage of a connection node N1 (=midpoint voltage) by the amount of the voltage drop, and low-side signal CANL occurring at the CANL terminal is a voltage lower than the voltage of the connection node N1 (=midpoint voltage) by the amount of the voltage drop. In this case, the high-side signal CANH is at a high level, and the low-side signal CANL is at a low level.

Herein, the CANH terminal and the CANL terminal are each connected to an application terminal of a power supply voltage VCC2 via resistors R41 and R42. When the PMOS transistor 42A and the NMOS transistor 42C are in the off-state, a voltage at the connection node N1 gradually approaches the second power supply voltage VCC2 due to an action of the resistors R41 and R42 which have relatively high resistance values. The second power supply voltage VCC2 is a low level of the high-side signal CANH and a high level of the low-side signal CANL, and is the same voltage as the above intermediate voltage.

As such, the transmission data TX input to the TXD terminal 40B is output from the CANH terminal and the CANL terminal to the CAN bus 35.

Meanwhile, the output section 44 comprises a PMOS transistor 44A and an NMOS transistor 44B. A source of the PMOS transistor 44A is connected to the application terminal of the power supply voltage VCC. A drain of the PMOS transistor 44A is connected to a drain of the NMOS transistor 44B at a node N42. A source of the NMOS transistor 44B is connected to the ground terminal. A voltage of the CANH terminal and a voltage of the CANL terminal are respectively input to the receiver 43. An output terminal of the receiver 43 is connected to a node N41, where a gate of the PMOS transistor 44A and a gate of the NMOS transistor 44B are connected. The node N42 is connected to the RXD terminal 40A.

The receiver 43 applies a high-level or low-level signal to the node N41 according to a differential of input voltages. Thus, the output section 44 outputs a signal obtained by logically inverting the output of the receiver 43 from the RXD terminal 40A to an outside as the reception data RX. As such, data input from the CAN bus 35 is output from the RXD terminal 40A.

When the high-side signal CANH is at a high level and the low-side signal CANL is at a low level, it is called “dominant,” and when the high-side signal CANH is at a low level and the low-side signal CANL is at a high level, it is called “recessive.” The dominant state takes precedence over the recessive state.

With this configuration, when transmission data TX is input to the CAN transceiver 40, the driver 42 is driven. At this time, if the reception data RX is transmitted from the CAN transceiver 30 (CAN bus 35) side, there is a possibility that the reception data RX may be changed by the high-side signal CANH and the low-side signal CANL driven by the driver 42. This is because in the case that the CAN transceiver 30 side is in the recessive state, the high-side signal CANH and the low-side signal CANL based on the transmission data TX may be in the dominant state.

Furthermore, it is possible not to provide a CAN transceiver between the MCU 20 and the semiconductor device 1; however, in that case, if the MCU 20 does not support simultaneous transmission of reception data RX and reception of transmission data TX, it is necessary to store the transmission data BTX in a buffer as in this embodiment.

FIG. 18 is a timing chart showing a processing after the second data number frame ND2 in FIG. 16 in more detail. In FIG. 18, in order from top, each waveform example for reception data RX, transmission data TX, reception data BRX, transmission data BTX, chip select signal CS, and clock signal SCK is shown.

When the second data number frame ND2 is received, the control section 15 starts the through-output of the reception data RX at the stop bit ST of the second data number frame ND2 (timing t31). As a result, the data SPDT is through-output to the SPI device 100 as reception data BRX. At this time, the chip select signal CS is switched to active by the chip select signal output section 16 at the start bit S at the beginning of the data SPDT (timing t32). In FIG. 18, as an example, the chip select signal CS is active at a low level (chip select signal setting information CSF=0 (FIG. 12C)).

With Full Duplex, transmission data BTX is transmitted from the SPI device 100 simultaneously with the transmission of reception data BRX. In FIG. 18, as an example, the clock edge setting information CPOL=1 (FIG. 12B), and the clock signal SCK is output so that the falling edge matches the center of each bit of the transmission data BRX that is through-output of the data SPDT (timing t34). That is, the transmission data BTX is output at the rising edge of the clock signal SCK (timing t33). The transmission data BTX is stored in the buffer 152 as mentioned above.

When the number of frames of the reception data RX to be through-output reaches the number of frames indicated by the second data number frame ND2, the through-output is stopped by the control section 15 (timing t35). At this time, the chip select signal CS is set to a high level, and the active state is released.

Subsequently, the second transmitting section 14 adds a start bit S and a stop bit P to the data read from the buffer 152 to form a frame, and transmits it as transmission data TX. When the transmission data TX is transmitted by a number of frames obtained by subtracting a number of frames indicated by the second data number frame ND2 from a number of frames indicated by the first data number frame ND1, the processing is completed.

### 6. Application Example

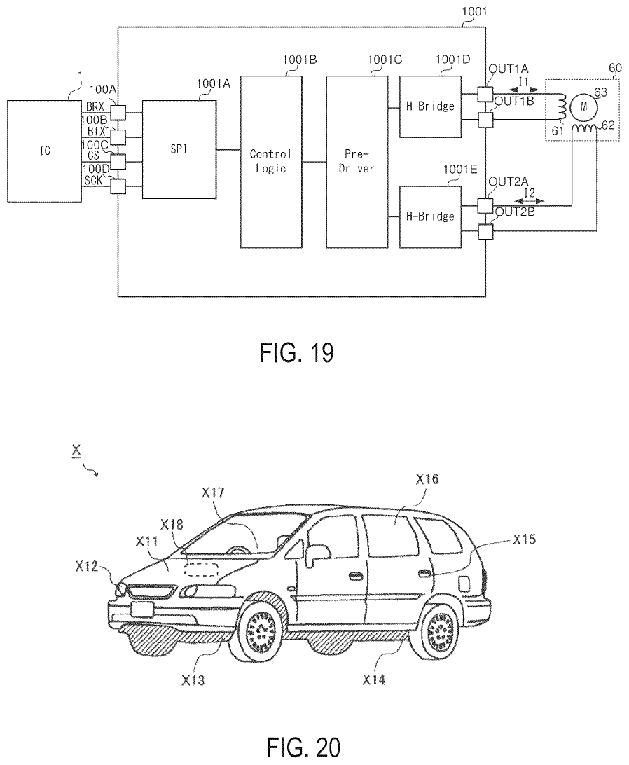

Next, a motor driver as a specific example of the SPI device 100 according to this embodiment is illustrated. FIG. 19 is a diagram showing a schematic configuration of a motor driver 1001.

The motor driver 1001 is configured to drive a two-phase excitation type stepping motor 60 (hereinafter simply referred to as a motor 60). The motor 60 comprises an excitation coil 61 for the first excitation phase, an excitation coil 62 for the second excitation phase, and a rotor 63. During a rotational drive of the motor 60, drive currents I1 and I2 are respectively supplied to the excitation coils 61 and 62 from the motor driver 1001.

The motor driver 1001 integrates and comprises an SPI communication section 1001A, a control logic section 1001B, a pre-driver 1001C, a half-bridge 1001D, and a half-bridge 1001E. Additionally, the motor driver 1001 comprises an RX terminal 100A, a TX terminal 100B, a CS terminal 100C, and an SCK terminal 100D as external terminals for establishing electrical connection with the outside. Moreover, the motor driver 1001 comprises output terminals OUT1A, OUT1B, OUT2A, OUT2B as external terminals.

The SPI communication section 1001A conducts communication via SPI with the semiconductor device 1. That is, as shown in FIG. 19, communication is conducted using reception data BRX, transmission data BTX, a chip select signal CS, and a clock signal SCK. As described above, since the semiconductor device 1 performs conversion between UART and SPI, the SPI communication section 1001A can conduct communication with an unillustrated MCU via the semiconductor device 1. By comprising the SPI communication section 1001A, it is possible to perform various settings for the motor driver 1001, output the state of the motor driver 1001 to the outside, etc.

The control logic section 1001B controls the entire motor driver 1001. The pre-driver 1001C drives the half-bridge 1001D and 1001E under a control of the control logic section 1001B. The half-bridge 1001D controls the drive current I1 by generating voltage signals at the output terminals OUT1A and OUT1B. The half-bridge 1001E controls the drive current I2 by generating voltage signals at the output terminals OUT2A and OUT2B.

### 7. Vehicle

FIG. 20 is an external view showing an example configuration of a vehicle X. The vehicle X of this configuration example is equipped with various electronic equipment X11 to X18 that operate by receiving power supply from an unillustrated battery. Furthermore, mounting positions of the electronic equipment X11 to X18 in FIG. 20 may differ from actual positions for convenience of illustration.

The electronic equipment X11 is an engine control unit that performs control related to an engine (injection control, electronic throttle control, idling control, oxygen sensor heater control, auto cruise control, etc.).

The electronic equipment X12 is a lamp control unit that performs control of turning on and off lights of HID [high intensity discharged lamp], DRL [daytime running lamp], etc.

The electronic equipment X13 is a transmission control unit that performs control related to a transmission.

The electronic equipment X14 is a body control unit that performs control related to a movement of the vehicle X (ABS [anti-lock brake system] control, EPS [electric power steering] control, electronic suspension control, etc.).

The electronic equipment X15 is a security control unit that performs drive control of door locks, security alarms, etc.

The electronic equipment X16 is electronic equipment that is installed in the vehicle X at a time of shipment from a factory as standard equipment or manufacturer option, such as wipers, electric door mirrors, power windows, dampers (shock absorbers), electric sunroofs, electric seats, etc.

The electronic equipment X17 is electronic equipment that is arbitrarily installed in the vehicle X as user options, such as in-vehicle A/V [audio/visual] equipment, a car navigation system, an ETC [electronic toll collection system], etc.

The electronic equipment X18 is electronic equipment that comprises a high-voltage motor, such as an in-vehicle blower, an oil pump, a water pump, a battery cooling fan, etc.

Furthermore, the communication system including the semiconductor device 1 and the motor driver 1001 (SPI device) and the motor 60 described above may be used to drive any of the electronic equipment X11 to X18. Additionally, if the vehicle X is an electric vehicle or a hybrid vehicle, the motor driver 1001 described above can be applied as a means for controlling a motor for driving wheels.

### 8. Other

Furthermore, in addition to the above embodiments, the various technical features disclosed in this specification can be modified in various ways without departing from the spirit of the technical creation. That is, the above embodiments should be considered in all respects as illustrative and not restrictive, and the technical scope of the present disclosure should not be limited to the above embodiments but should be understood to include all modifications that fall within the meaning and scope of claims and equivalents.

### 9. Appendix

As described above, a semiconductor device (1) according to one aspect of the present disclosure is configured that the semiconductor device comprises:
a first input terminal (1A);
a first output terminal (1B);
a second output terminal (1C);
a second input terminal (1D);
a first receiving section (11) configured to be able to receive serial data as reception data (RX) from an external transmitting device (20) via the first input terminal;
a first transmitting section (12) configured to be connectable to an external first device (100) via the second output terminal;
a second receiving section (13) configured to be connectable to the first device via the second input terminal;
a second transmitting section (14) configured to be connectable to the transmitting device via the first output terminal; and
a buffer (152),
wherein the first receiving section and the first transmitting section are configured such that when bridge selection data (BR) included in the reception data indicates an on-state of a through-output in which bit data is output as is, data (SPDT) for the first device included in the reception data is through-output from the second output terminal,
transmission data (BTX) received by the second receiving section via the second input terminal during the through-output of the reception data is stored in the buffer, and
the transmission data read from the buffer after the through-output of the reception data is output via the first output terminal by the second transmitting section (first configuration).

According to the above configuration, communication using Full Duplex with the first device that supports a protocol different from the semiconductor device itself can be conducted. Thus, a communication system can be effectively configured using a device that supports a protocol different from the semiconductor device itself.

Furthermore, in the first configuration, the semiconductor device may be configured so that in a Write process for writing to a register (151) included in the semiconductor device, Write data and data for CRC check are included in the reception data, and the buffer is used for temporarily storing the Write data (second configuration).

Furthermore, in the first or second configuration, the semiconductor device may be configured to be switchable and settable between a Full Duplex mode in which the transmission data is transmitted from the first device during the through-output of the reception data, and a Half Duplex mode in which the transmission data is transmitted from the first device after the through-output of the reception data (third configuration).

Furthermore, in any of the first to third configurations, the semiconductor device may be configured to comprise a clock signal output section (17) configured to output a clock signal (SCK) such that a falling edge or rising edge comes to a center of a bit of the reception data that is through-output (fourth configuration).

Furthermore, in any of the first to fourth configurations, the semiconductor device may be configured so that the reception data includes first frame number information indicating a number of frames for which the reception data is to be through-output, and second frame number information indicating a number of frames that is twice the number of frames indicated by the first frame number information (fifth configuration).

Furthermore, any of the first to fifth configurations, the semiconductor device may be configured so that a start bit and a stop bit are added to the transmission data read from the buffer to form a frame, which is output via the first output terminal (sixth configuration).

Furthermore, in any of the first to sixth configurations, the semiconductor device may be configured so that a serial communication method between the transmitting device and the semiconductor device is UART, and a serial communication method between the first device and the semiconductor device is SPI (seventh configuration).

Furthermore, one aspect of the present disclosure is a communication system comprising the semiconductor device having any of the first to seventh configurations, the transmitting device, and the first device (eighth configuration).

Furthermore, in the eighth configuration, a transceiver (30, 40) of differential voltage method may be provided between the transmitting device and the semiconductor device (ninth configuration).

Furthermore, in the eighth or ninth configuration, the first device may be configured as a motor driver (1001) (tenth configuration).

Furthermore, in the tenth configuration, the communication system may be mountable

in a vehicle (X) (eleventh configuration).

### INDUSTRIAL APPLICABILITY

The present disclosure can be utilized, for example, in communication systems for various applications.

1. A semiconductor device, comprising:
a first input terminal;
a first output terminal;
a second output terminal;
a second input terminal;
a first receiving section configured to be able to receive serial data as reception data from an external transmitting device via the first input terminal;
a first transmitting section configured to be connectable to an external first device via the second output terminal;
a second receiving section configured to be connectable to the first device via the second input terminal;
a second transmitting section configured to be connectable to the transmitting device via the first output terminal; and
a buffer,
wherein the first receiving section and the first transmitting section are configured such that when bridge selection data included in the reception data indicates an on-state of a through-output in which bit data is output as is, data for the first device included in the reception data is through-output from the second output terminal,
transmission data received by the second receiving section via the second input terminal during the through-output of the reception data is stored in the buffer, and
the transmission data read from the buffer after the through-output of the reception data is output via the first output terminal by the second transmitting section.

2. The semiconductor device of claim 1, wherein in a Write process for writing to a register included in the semiconductor device, Write data and data for CRC check are included in the reception data, and the buffer is used for temporarily storing the Write data.

3. The semiconductor device of claim 1, wherein the semiconductor device is configured to be switchable and settable between a Full Duplex mode in which the transmission data is transmitted from the first device during the through-output of the reception data, and a Half Duplex mode in which the transmission data is transmitted from the first device after the through-output of the reception data.

4. The semiconductor device of claim 1, comprising a clock signal output section configured to output a clock signal such that a falling edge or rising edge comes to a center of a bit of the reception data that is through-output.

5. The semiconductor device of claim 1, wherein the reception data includes first frame number information indicating a number of frames for which the reception data is to be through-output, and second frame number information indicating a number of frames that is twice the number of frames indicated by the first frame number information.

6. The semiconductor device of claim 1, wherein a start bit and a stop bit are added to the transmission data read from the buffer to form a frame, which is output via the first output terminal.

7. The semiconductor device of claim 1, wherein a serial communication method between the transmitting device and the semiconductor device is UART, and a serial communication method between the first device and the semiconductor device is SPI.

8. A communication system, comprising the semiconductor device of claim 1, the transmitting device, and the first device.

9. The communication system of claim 8, wherein a transceiver of differential voltage method is provided between the transmitting device and the semiconductor device.

10. The communication system of claim 8, wherein the first device is configured as a motor driver.

11. The communication system of claim 10, which is mountable in a vehicle.
